(19) United States
(12) Patent Application Publication
(10) Pub. No.: US 2011/0031717 A1
(43) Pub. Date: Feb. 10, 2011

(54) APPARATUS, METHOD, AND KIT FOR MODIFYING A STOCK INVERTED FRONT FORK ASSEMBLY OF A MOTORCYCLE

(76) Inventor: Jonathan J. Martin, Longs, SC (US)

Correspondence Address: HAHN LOESER & PARKS, LLP, One GOJO Plaza, Suite 300, AKRON, OH, 44311-1076, US

(21) Appl. No.: 12/718,176

(22) Filed: Mar. 5, 2010

Related U.S. Application Data
(60) Provisional application No. 61/157,662, filed on Mar. 5, 2009.

(51) Int. Cl. B62K 21/02; B23P 17/00

(52) U.S. Cl. 280/276; 29/401.1

(57) ABSTRACT

An apparatus, method, and kit for modifying a stock inverted front fork assembly of a motorcycle. The resultant modified stock inverted front fork assembly includes shortened lower stock cartridge components of a factory stock inverted front fork assembly, and an air cylinder assembly operatively connected to the shortened lower stock cartridge components of the factory stock inverted front fork assembly. The air cylinder assembly has a cylinder body capable of being screwed into a top portion of a stock fork tube, a piston inside of the cylinder body, a spring button attachment point, and a shaft connected to the piston at a proximal end of the shaft and connected to the spring button attachment point at a distal end of the shaft.

This U.S. Patent Application claims the benefit of and priority to provisional U.S. Patent Application Ser. No. 61/157,662 filed on Mar. 5, 2009, which is incorporated herein by reference in it entirety.

### TECHNICAL FIELD

Certain embodiments of the present invention relate to motorcycles. More particularly, certain embodiments relate to stock inverted front fork assemblies of motorcycles.

### BACKGROUND

A typical motorcycle has a pair of front fork tubes to provide suspension for the front of the motorcycle. A common type of front fork is a telescopic fork which is hydraulically damped, having hydraulic shock absorbers with internal coil springs. The top portions of the forks are connected to the frame of the motorcycle, and the bottom portions of the forks are connected to the front axle of the motorcycle. Conventional front forks have an upper portion called the fork tube which slides into a lower portion called a fork body in a telescoping arrangement. Upside-down (USD) or inverted front forks are installed in an inverted manner compared to conventional front forks such that the fork body is at the top and the tube is at the bottom. Such an inverted configuration tends to decrease the unsprung weight of the motorcycle and provides improved handling.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a modified stock inverted front fork assembly for a motorcycle. The modified front fork assembly includes modified lower stock suspension components of a factory stock inverted front fork assembly. The modified front fork assembly also includes an air cylinder assembly operatively connected to the modified lower stock suspension components of the factory stock inverted front fork assembly. The air cylinder assembly may include a cylinder body capable of screwing into a top portion of a stock fork tube, a piston inside of the cylinder body, a spring button attachment point, and a shaft connected to the piston at a proximal end of the shaft and connected to the spring button attachment point at a distal end of the shaft. The modified lower stock suspension components may include at least one of a lower tube portion, at least one rod within the lower tube portion, at least one spring, and at least one valve. The shaft of the air cylinder assembly may be capable of being extended outward from the cylinder body by up to four inches. The shaft of the air cylinder assembly may be capable of being extended outward from the cylinder body to raise a front end of a motorcycle to an original equipment manufacturer height for the motorcycle. The shaft of the air cylinder assembly may be capable of being extended outward from the cylinder body to provide a riding adjustment range of two inches to four inches. The modified lower stock suspension components may be incorporated into a cartridge type of configuration.

Another embodiment of the present invention comprises an inverted front fork assembly kit for a motorcycle. The kit includes at least one air cylinder assembly capable of being driven between a fully extended position and a fully contracted position by an air compressor. The kit further includes at least one replacement suspension cartridge capable of being connected to the at least one air cylinder assembly. The kit also includes at least one air hose capable of being operatively connected between said at least one air cylinder assembly and an air compressor installed on a motorcycle. The air cylinder assembly may include a cylinder body capable of screwing into a top portion of a stock fork tube, a piston inside of the cylinder body, a spring button attachment point, and a shaft connected to the piston at a proximal end of the shaft and connected to the spring button attachment point at a distal end of the shaft. The at least one replacement suspension cartridge may include a lower tube portion, at least one rod within the lower tube portion, at least one spring, and at least one valve. The kit may further include an air compressor capable of being installed on a motorcycle. The shaft of the air cylinder assembly may be capable of being extended outward from the cylinder body by up to four inches. The shaft of the air cylinder assembly may be capable of being extended outward from the cylinder body to raise a front end of a motorcycle to an original equipment manufacturer height for the motorcycle. The shaft of the air cylinder assembly may be capable of being extended outward from the cylinder body to provide a riding adjustment range of two inches to four inches.

A further embodiment of the present invention comprises a method of modifying a stock inverted front fork assembly of a motorcycle. The method includes removing a factory cap from an upper portion of a stock inverted front fork assembly. The method further includes shortening a length of at least some lower stock components of the stock inverted front fork assembly from a factory length. The method also includes substituting an air cylinder assembly for the factory cap in the upper portion of the stock inverted front fork assembly. The method further includes connecting a lower portion of the air cylinder assembly to an upper portion of the shortened lower stock components. The at least some lower stock components may include at least one of a lower tube portion, at least one rod within the lower tube portion, at least one spring, and at least one valve. The air cylinder assembly may include a cylinder body capable of being screwed into an upper portion of a stock fork tube, a piston inside of the cylinder body, a spring button attachment point, and a shaft connected to the piston at a proximal end of the shaft and connected to the spring button attachment point at a distal end of the shaft. The shaft of the air cylinder assembly may be capable of being extended outward from the cylinder body by up to four inches. The shaft of the air cylinder assembly may be capable of being extended outward from the cylinder body to raise a front end of a motorcycle to an original equipment manufacturer height for the motorcycle. The shaft of the air cylinder assembly may be capable of being extended outward from the cylinder body to provide a riding adjustment range of two inches to four inches. The method may further include incorporating the at least some lower stock components into a cartridge type of configuration.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates an embodiment of an air cylinder assembly for a stock inverted front fork;

FIG. 2 illustrates an embodiment of the air cylinder assembly of FIG. 1 operatively connected to modified stock suspension components of a stock inverted front fork;

FIG. 3 is a flow chart of an embodiment of a method for modifying a stock inverted front fork assembly with the air cylinder assembly of FIG. 1;

FIG. 4 illustrates an embodiment of an inverted from fork assembly kit for a motorcycle; and

FIG. 5 illustrates and embodiment of a user interface capable of being operatively connected to an air compressor on a motorcycle.

### DETAILED DESCRIPTION

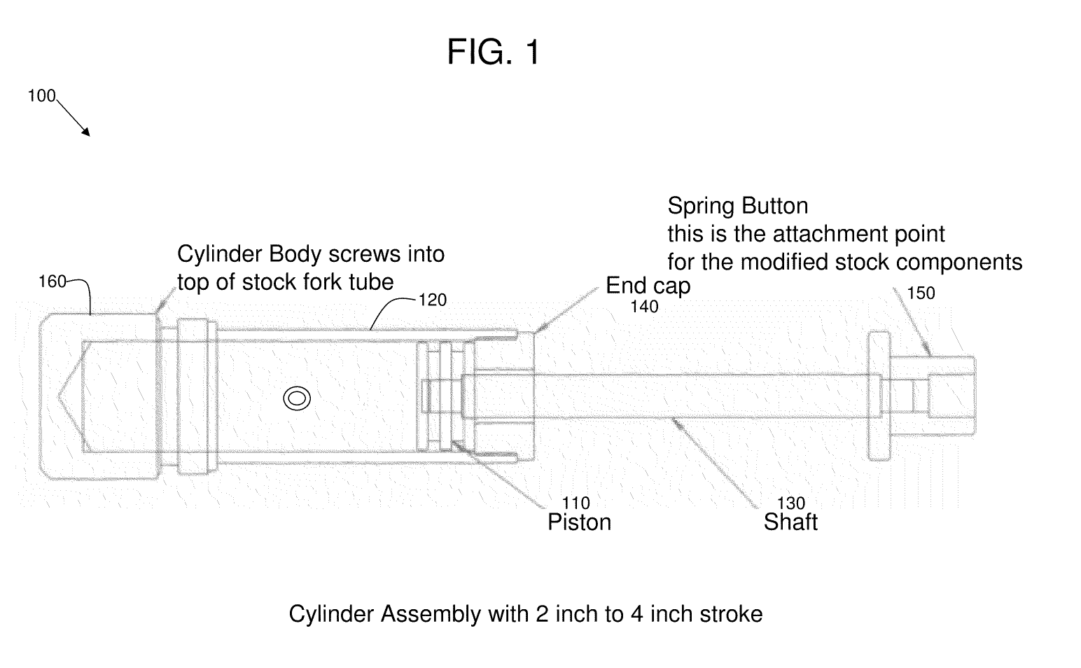

FIG. 1 illustrates an embodiment of an air cylinder assembly 100 for a stock inverted front fork. The air cylinder assembly 100 includes a piston 110 within a cylinder body 120. The air cylinder assembly 100 further includes a shaft 130 connected to the piston 110 through an end cap 140. The air cylinder assembly 100 also includes a spring button attachment 150 connected to an opposite end of the shaft 130. The air cylinder assembly 100, when operatively connected to an air compressor via, for example, an air hose, is capable of extending the shaft 130 outward from the cylinder body 120 up to four inches. In accordance with an embodiment of the present invention, the cylinder body 120 is capable of screwing into a top of a stock fork tube 160 of a frame of a motorcycle.

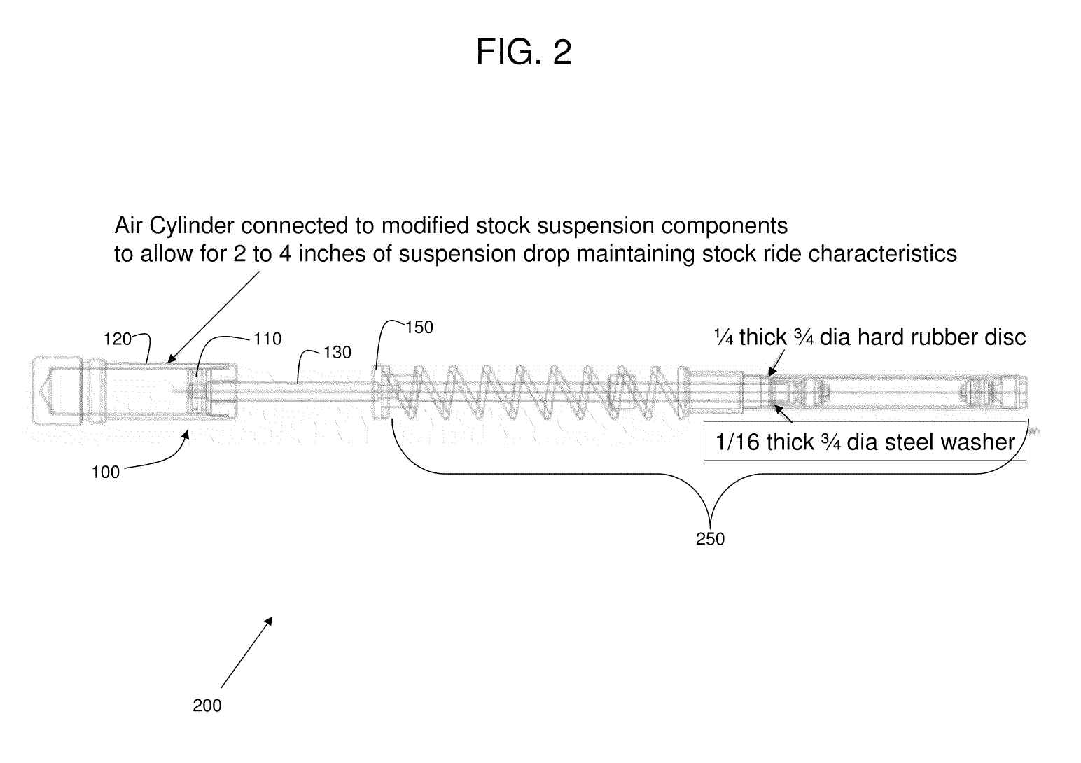

FIG. 2 illustrates an embodiment of the air cylinder assembly 100 of FIG. 1 operatively connected to modified stock suspension components 250 of a stock inverted front fork. The modified stock suspension components 250 may include, for example, a lower tube portion, rods within the lower tube portion, a spring, and valves providing dampening and suspension. Such stock suspension components are well known in the art for stock inverted front forks and are often provided in a cartridge type of configuration. However, in the embodiment of FIG. 2, certain elements of the stock suspension components 250 have been shortened from a factory length in order to accommodate insertion of the air cylinder assembly 100.

In accordance with an embodiment of the present invention, the lower tube portion and the rods are shortened, but the spring is not shortened. The spring button attachment 150 of the air cylinder assembly 100 is connected to the modified stock suspension components 250 after the certain elements of the stock suspension components 250 have been shortened. As a result, the air cylinder assembly 100 and the connected modified stock suspension components 250 constitute a modified stock inverted front fork assembly 200.

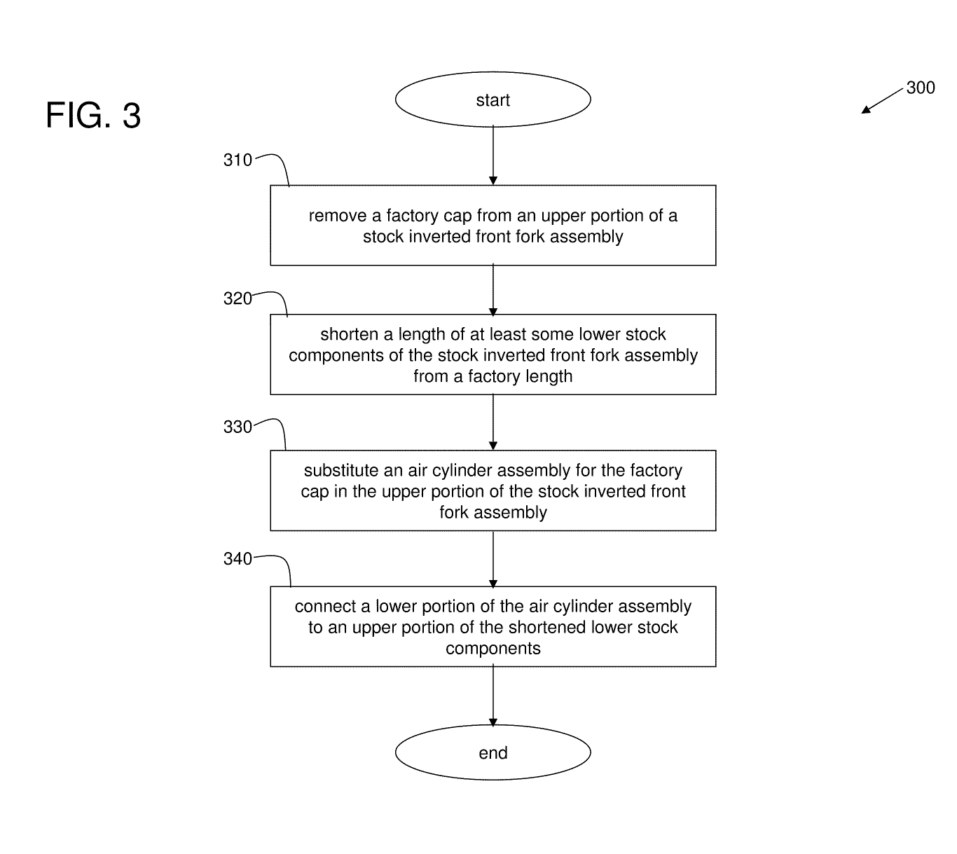

FIG. 3 is a flow chart of an embodiment of a method 300 for modifying a stock inverted front fork assembly with the air cylinder assembly 100 of FIG. 1. In step 310 of the method 300, remove a factory cap from an upper portion of a stock inverted front fork assembly. In step 320, shorten a length of at least some lower stock components 250 of the stock inverted front fork assembly from a factory length. In step 330, substitute an air cylinder assembly 100 for the factory cap in the upper portion of the stock inverted front fork assembly. Therefore, the factory cap is replaced with the air cylinder assembly 100. In step 340, connect a lower portion 150 of the air cylinder assembly 100 to an upper portion of the shortened lower stock components 250.

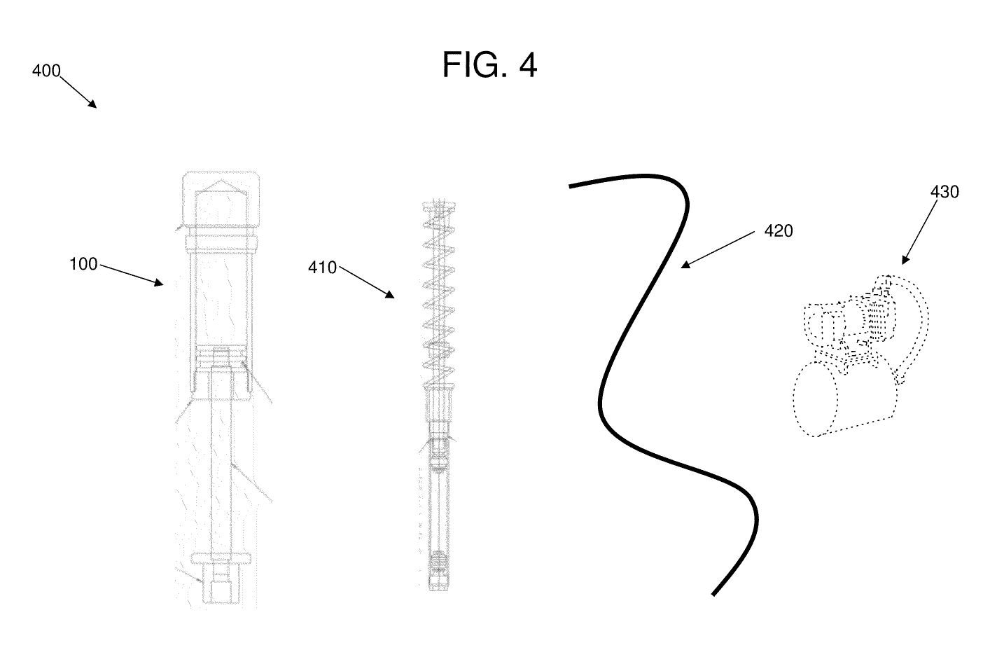

A pair of modified stock inverted front fork assemblies 200, each having an air cylinder assembly 100, may be installed in a motorcycle and connected to an air compressor via, for example, an air hose. The air compressor may already be installed on the motorcycle in order to provide compressed air for a rear air ride suspension of the motorcycle. Alternatively (or optionally), a new air compressor 430 (see FIG. 4) may be installed on the motorcycle and operatively connected to the air cylinder assemblies 100 of the two modified stock inverted front fork assemblies 200.

The air cylinder assemblies 100 of the modified stock inverted front fork assemblies 200 allow the front end of the motorcycle to be lowered from a maximum height position by as much as four inches, in accordance with an embodiment of the present invention. Such lowering of the front end helps to lower the center of gravity of the motorcycle and may be desirable to do, for example, in drag racing events. Such lowering of the front end may also be desirable when a rider stops at a stop sign or a stop light, to provide better stability of the motorcycle when the motorcycle is not moving. Furthermore, such lowering of the front end may be desirable when a rider parks the motorcycle and gets off of the motorcycle.

When the cylinder assemblies 100 are in the fully extended or up position, the front end of the motorcycle is raised to a normal OEM (original equipment manufacturer) or factory height for the motorcycle, and the motorcycle rides with substantially the same front end characteristics of the original factory front end (i.e., as if the stock inverted front forks have not been modified). In accordance with an embodiment of the present invention, the cylinder assemblies 100 may be controlled via the air compressor to provide a riding adjustment range of two inches to four inches of extension from the fully lowered position. Such adjustment may be desirable to accommodate riders of different heights and leg lengths, for example.

An embodiment of the present invention includes an inverted front fork assembly kit 400 including an air cylinder assembly 100 and a cartridge replacement 410, as illustrated in FIG. 4. The cartridge replacement 410 is similar to the shortened lower stock components 250 of FIG. 2. The kit 400 may further include an air hose 420 capable of operatively connecting the air cylinder assembly 100 to an air compressor installed on the motorcycle. Optionally, the kit may also include an air compressor that may be installed on the motorcycle to be connected to the air hose 420. With such a kit 400, a user may replace an OEM or factory provided stock inverted front fork assembly with the kit 400. Alternatively, the OEM or factory provided stock inverted front fork assembly may be modified to shorten the cartridge components (i.e., the stock suspension components 250) and the air cylinder assembly 100 may be inserted and connected, as described above, to form a modified stock inverted front fork assembly 200.

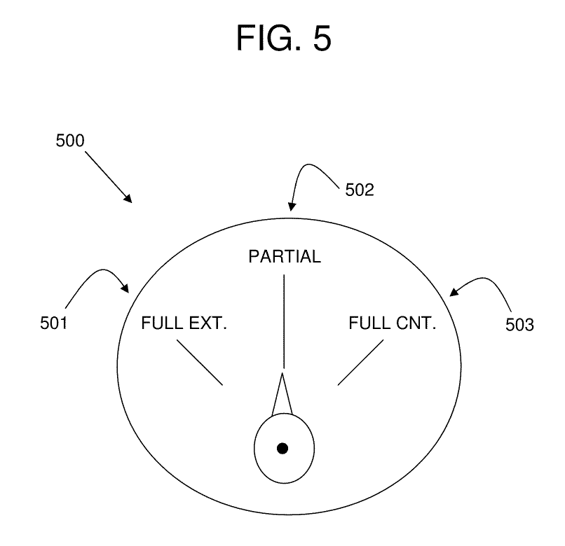

An embodiment of the present invention may include a user interface 500 such as, for example, a multi-position switch (as shown in FIG. 5) operatively connected to an air compressor. For example, the switch 500 may include three positions allowing the air cylinder assembly 100 to be driven to any of a fully extended (raised) position 501, a partially extended position 502, or a fully contracted (lowered) position 503 by the air compressor.

In summary, an apparatus, method, and kit for modifying a stock inverted front fork assembly of a motorcycle are disclosed. The resultant modified stock inverted front fork assembly includes shortened lower stock cartridge components of a factory stock inverted front fork assembly, and an air cylinder assembly operatively connected to the shortened lower stock cartridge components of the factory stock inverted front fork assembly. The air cylinder assembly has a cylinder body capable of being screwed into a top portion of a stock fork tube, a piston inside of the cylinder body, a spring button attachment point, and a shaft connected to the piston at a proximal end of the shaft and connected to the spring button attachment point at a distal end of the shaft.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A modified stock inverted front fork assembly for a motorcycle, said front fork assembly comprising:
modified lower stock suspension components of a factory stock inverted front fork assembly; and
an air cylinder assembly operatively connected to said modified lower stock suspension components of said factory stock inverted front fork assembly and capable of being driven between a fully extended position and a fully contracted position by an air compressor.

2. The modified stock inverted front fork assembly of claim 1 wherein said air cylinder assembly includes a cylinder body capable of screwing into a top portion of a stock fork tube, a piston inside of said cylinder body, a spring button attachment point, and a shaft connected to said piston at a proximal end of said shaft and connected to said spring button attachment point at a distal end of said shaft.

3. The modified stock inverted front fork assembly of claim 1 wherein said modified lower stock suspension components include at least one of a lower tube portion, at least one rod within said lower tube portion, at least one spring, and at least one valve.

4. The modified stock inverted front fork assembly of claim 2 wherein said shaft of said air cylinder assembly is capable of being extended outward from said cylinder body by up to four inches.

5. The modified stock inverted front fork assembly of claim 2 wherein said shaft of said air cylinder assembly is capable of being extended outward from said cylinder body to raise a front end of a motorcycle to an original equipment manufacturer height for the motorcycle.

6. The modified stock inverted front fork assembly of claim 2 wherein said shaft of said air cylinder assembly is capable of being extended outward from said cylinder body to provide a riding adjustment range of two inches to four inches.

7. The modified stock inverted front fork assembly of claim 1 wherein said modified lower stock suspension components are incorporated into a cartridge type of configuration.

8. An inverted front fork assembly kit for a motorcycle, said kit comprising:
at least one air cylinder assembly capable of being driven between a fully extended position and a fully contracted position by an air compressor;
at least one replacement suspension cartridge capable of being connected to said at least one air cylinder assembly; and
at least one air hose capable of being operatively connected between said at least one air cylinder assembly and an air compressor installed on a motorcycle.

9. The kit of claim 8 wherein said at least one air cylinder assembly includes a cylinder body capable of screwing into a top portion of a stock fork tube, a piston inside of said cylinder body, a spring button attachment point, and a shaft connected to said piston at a proximal end of said shaft and connected to said spring button attachment point at a distal end of said shaft.

10. The kit of claim 8 wherein said at least one replacement suspension cartridge includes a lower tube portion, at least one rod within said lower tube portion, at least one spring, and at least one valve.

11. The kit of claim 8 further comprising an air compressor capable of being installed on a motorcycle.

12. The kit of claim 9 wherein said shaft of said air cylinder assembly is capable of being extended outward from said cylinder body by up to four inches.

13. The kit of claim 9 wherein said shaft of said air cylinder assembly is capable of being extended outward from said cylinder body to raise a front end of a motorcycle to an original equipment manufacturer height for the motorcycle.

14. The kit of claim 9 wherein said shaft of said air cylinder assembly is capable of being extended outward from said cylinder body to provide a riding adjustment range of two inches to four inches.

15. A method of modifying a stock inverted front fork assembly of a motorcycle, said method comprising:
removing a factory cap from an upper portion of a stock inverted front fork assembly;
shortening a length of at least some lower stock components of the stock inverted front fork assembly from a factory length;
substituting an air cylinder assembly for said factory cap in said upper portion of said stock inverted front fork assembly; and
connecting a lower portion of said air cylinder assembly to an upper portion of said shortened lower stock components.

16. The method of claim 15 wherein said at least some lower stock components include at least one of a lower tube portion, at least one rod within said lower tube portion, at least one spring, and at least one valve.

17. The method of claim 15 wherein said air cylinder assembly includes a cylinder body capable of being screwed into an upper portion of a stock fork tube, a piston inside of said cylinder body, a spring button attachment point, and a shaft connected to said piston at a proximal end of said shaft and connected to said spring button attachment point at a distal end of said shaft.

18. The method of claim 17 wherein said shaft of said air cylinder assembly is capable of being extended outward from said cylinder body by up to four inches.

19. The method of claim 17 wherein said shaft of said air cylinder assembly is capable of being extended outward from said cylinder body to raise a front end of a motorcycle to an original equipment manufacturer height for the motorcycle.

20. The method of claim 17 wherein said shaft of said air cylinder assembly is capable of being extended outward from said cylinder body to provide a riding adjustment range of two inches to four inches.

21. The method of claim 17 further comprising incorporating said at least some lower stock components into a cartridge type of configuration.
